(19) United States
(12) Patent Application Publication
(10) Pub. No.: US 2026/0261518 A1
(43) Pub. Date: Sep. 3, 2026

(54) METHODS, APPARATUSES AND SYSTEMS FOR CONFIGURING A NETWORK-ENDPOINT USER-PLANE METADATA

(71) Applicant: InterDigital Patent Holdings, Inc., Wilmington, DE (US)

(72) Inventors: Xavier De Foy, Kirkland (CA); Michael Starsinic, Newtown, PA (US); Hyunsik Yang, Leonia, NJ (US); Rocco Di Girolamo, Laval (CA); Ahmed Hamza, Coquitlam (CA); Srinivas Gudumasu, Montreal (CA)

(21) Appl. No.: 19/066,380

(22) Filed: Feb. 28, 2025

(51) Int. Cl. H04L 47/24; H04L 47/19

(52) U.S. Cl. CPC H04L 47/24; H04L 47/19

(57) ABSTRACT

In an embodiment, a method, implemented in an entity of a core network, comprises receiving a first message comprising first information indicating usage of metadata parameters for data flow communication between network endpoint nodes; receiving, from a first network endpoint node, a second message comprising second information indicating a first request for providing the metadata parameters related to the data flow communication with a second network endpoint node; transmitting, to the first network endpoint node, a third message comprising third information indicating the metadata parameters; receiving, from the second network endpoint node, a data flow; performing measurements on the data flow based on the one or more metadata parameters; and transmitting, to the first network endpoint node, a fourth message comprising fourth information indicating conformance information based on results of the measurements.

### FIELD OF THE INVENTION

The present disclosure is generally directed to methods, architecture apparatuses and systems for configuring a network-endpoint user-plane metadata. More particularly, the present disclosure relates to methods to configure a network to use Network-Endpoint User-Plane Metadata (NUM) for a flow.

### BACKGROUND

In standard communication with network elements protocol, network-endpoint user-plane metadata (NUM) data messages may be a message, e.g., a Quick User Datagram Protocol Internet Connections (QUIC) packets with a specific version (e.g., distinct from regular QUIC versions 1 and 2), which may be sent adjacent to the end-to-end QUIC connection or coalesced with a Protocol Data Unit (PDU) of the end-to-end QUIC connection. A message adjacent to the end-to-end QUIC connection share important characteristics with PDUs of the end-to-end connection, e.g., it uses the same 5-tuple as the end-to-end connection (where the 5-tuple is composed of source and destination IP address and UDP ports, and transport protocol). A message coalesced with a PDU of the end-to-end QUIC connection is sent in the same packet (e.g., same IP packet and/or same UDP datagram) as the PDU of the end-to-end QUIC connection. A client (e.g., a user equipment (UE)) may send a NUM data request message at any time, and a proxy (e.g., User Plane Function (UPF)) may identify it and reply to it with a NUM data response message including NUM data.

In transparent rate adaptation indications for networks protocol, NUM data messages may be QUIC packets with a specific version (e.g., distinct from regular QUIC versions 1 and 2), which may be sent coalesced with an end-to-end QUIC packet, i.e., in the same UDP datagram as an end-to-end packet. An initial sender may be an endpoint (e.g., user equipment or application server (AS)). A proxy (e.g., UPF) may detect the NUM data message and modify it to add the NUM data value. A receiver endpoint (e.g., AS or UE) may retrieve the NUM data value from the NUM data message.

In a MASQUE extension for signaling throughput advice, NUM data may be transmitted in a MASQUE control message within a MASQUE tunnel between a UE and a UPF. This NUM protocol may be used, for example, in a case where a MASQUE tunnel is established for other purposes (e.g., as part of a multi-access PDU session using a multi path quick user datagram protocol internet connections MPQUIC steering functionality). The UPF or the UE, in this case, may send NUM data to each other in MASQUE control message (e.g., HTTP datagram messages sent in a control stream of the MASQUE connection).

In a discovery of network rate-limit policies protocol (NLRP), a network may transmit NUM data in messages such as router advertisements or Dynamic Host Configuration Protocol (DHCP) messages.

Other NUM protocol examples may include: real-time protocol (RTP) header extensions, user datagram protocol (UDP) header options, internet protocol (IP) header options, media over QUIC (MOQ) metadata extensions.

NUM mechanisms may be different from protocol data unit (PDU) set transmission mechanisms, notably since PDU set transmission mechanisms do not enable transmission of metadata from the network to the endpoint. There is currently no mechanism enabling a mobile network to use a NUM protocol, e.g., to transmit metadata from a network to an endpoint.

There is a need to resolve the above issues.

### SUMMARY

In an embodiment, a method, implemented in an entity of a core network, may comprise a step of receiving a first message comprising first information indicating usage of one or more metadata parameters for data flow communication between network endpoint nodes through the core network. The method may comprise a step of receiving, from a first network endpoint node, a second message comprising second information indicating a first request for providing the one or more metadata parameters related to the data flow communication with a second network endpoint node. The method may further comprise a step of transmitting, to the first network endpoint node, a third message comprising third information indicating the one or more metadata parameters related to the data flow communication with the second network endpoint node. The method may further comprise a step of receiving, from the second network endpoint node, a data flow. The method may further comprise a step of performing one or more measurements on the data flow based on the one or more metadata parameters; and a step of transmitting to any of the first network endpoint node, the second network endpoint node, another entity of the core network, and a radio access network node in communication with the first network endpoint node, a fourth message comprising fourth information indicating conformance information based on one or more results of the one or more measurements. The fourth message may be transmitted coalesced or adjacent with a packet data unit transmitted to the first network endpoint node.

The method may further comprise a step of transmitting to the radio access network node in communication with the first network endpoint node, the fourth message comprising a second request for handling a quality of service based on the conformance information.

The one or more metadata parameters may be related to a network-endpoint user plane metadata mechanism involving at least the entity of the core network. The entity of the core network may be a user plane function entity. The one or more metadata parameters may indicate data flow rate for communicating the data flow.

The method may comprise a step of receiving a fifth message comprising fifth information indicating one or more triggering conditions for transmitting the third information. The one or more triggering conditions may comprise any of: (i) starting of communication of the data flow, (ii) a relocation of the first network endpoint node from one or more current network entities to one or more new network entities of the network, (iii) receiving the second message, (iv) a usage of the core network has changed, (v) metadata parameters changed, and (vi) a timer elapsed. The method may comprise a step of receiving the fifth message from the first network endpoint node, the second network endpoint node, or from another entity of the core network.

The method may further comprise a step of transmitting, to the another entity of the core network, a seventh message comprising a third request for providing the one or more metadata parameters to the entity of the core network; and a step of receiving, from the another entity of the core network, a response message to the third request comprising information indicating the one or more metadata parameters.

In an embodiment, an entity of a core network comprising a processor, and a memory, may be configured to receive a first message comprising first information indicating usage of one or more metadata parameters for data flow communication between network endpoint nodes through the core network. The entity of the core network may be configured to receive, from a first network endpoint node, a second message comprising second information indicating a first request for providing the one or more metadata parameters related to the data flow communication with a second network endpoint node. The entity of the core network may be configured to transmit, to the first network endpoint node, a third message comprising third information indicating the one or more metadata parameters related to the data flow communication with the second network endpoint node. The entity of the core network may be configured to receive, from the second network endpoint node, a data flow. The entity of the core network may be configured to perform one or more measurements on the data flow based on the one or more metadata parameters; and the entity of the core network may be configured to transmit, to any of the first network endpoint node, the second network endpoint node, another entity of the core network, and a radio access network node in communication with the first network endpoint node, a fourth message comprising fourth information indicating conformance information based on one or more results of the one or more measurements.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a flow chart illustrating an example of main aspects of a high level solution for NUM, according to an embodiment;

FIG. 3 is an example of a signalling diagram illustrating an example of a procedure for NUM configuration, according to an embodiment;

FIG. 4 is an example of a signalling diagram illustrating an example of a procedure for NUM operation, according to an embodiment;

FIG. 5 is an example of a signalling diagram illustrating an example of a procedure for NUM conformance measurement and usage, according to an embodiment; and

FIG. 6 is an example of a flow chart illustrating an example of a method implemented in an entity of a core network to configure a network to use network-endpoint user-plane metadata (NUM) for a data flow according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’may imply ‘A and/or B’.

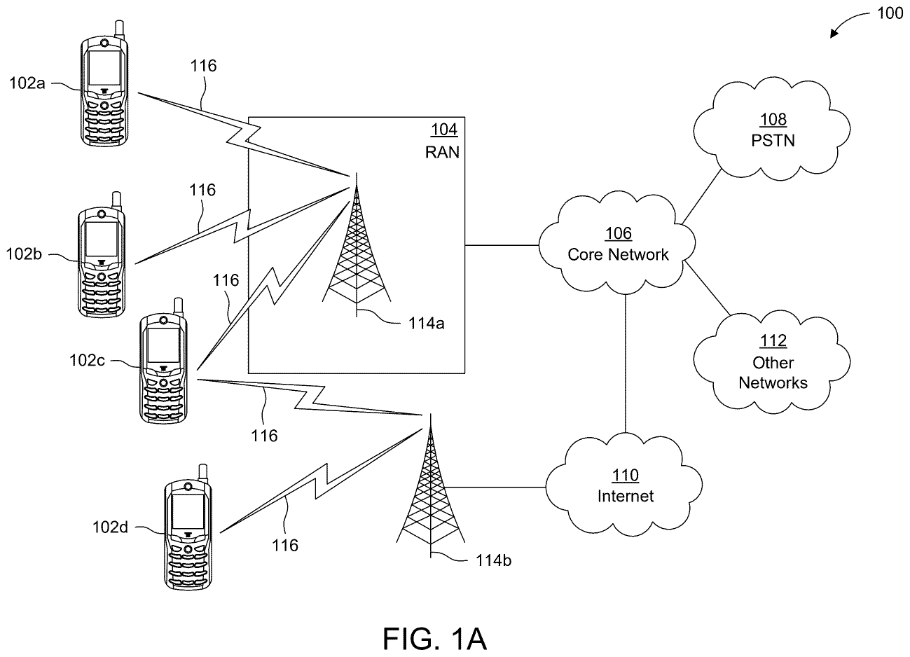

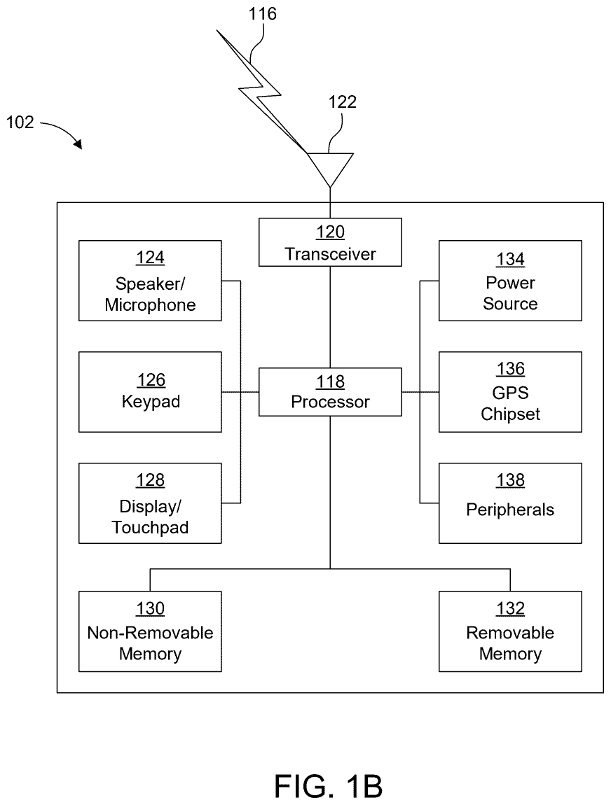

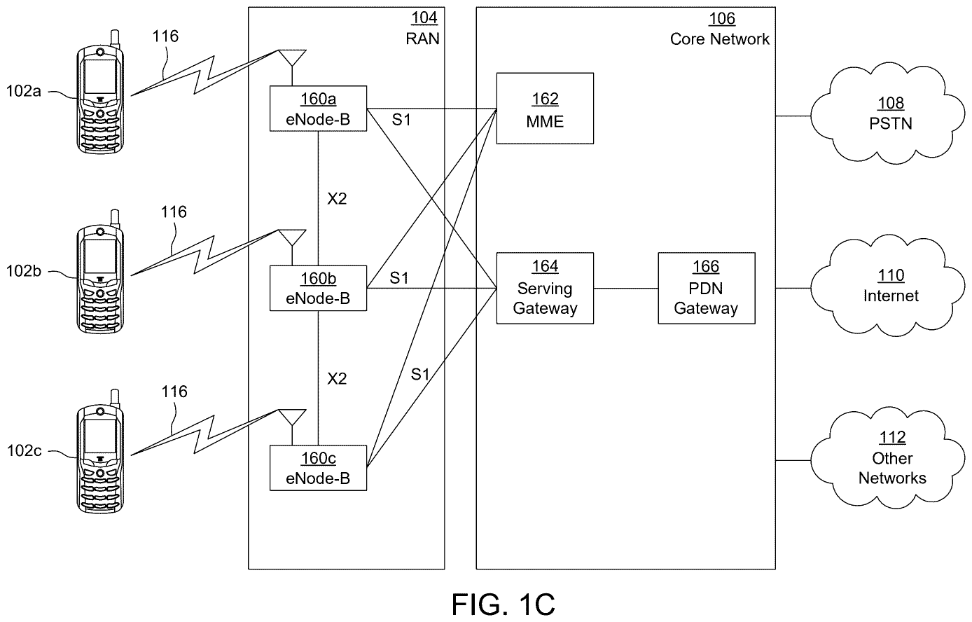

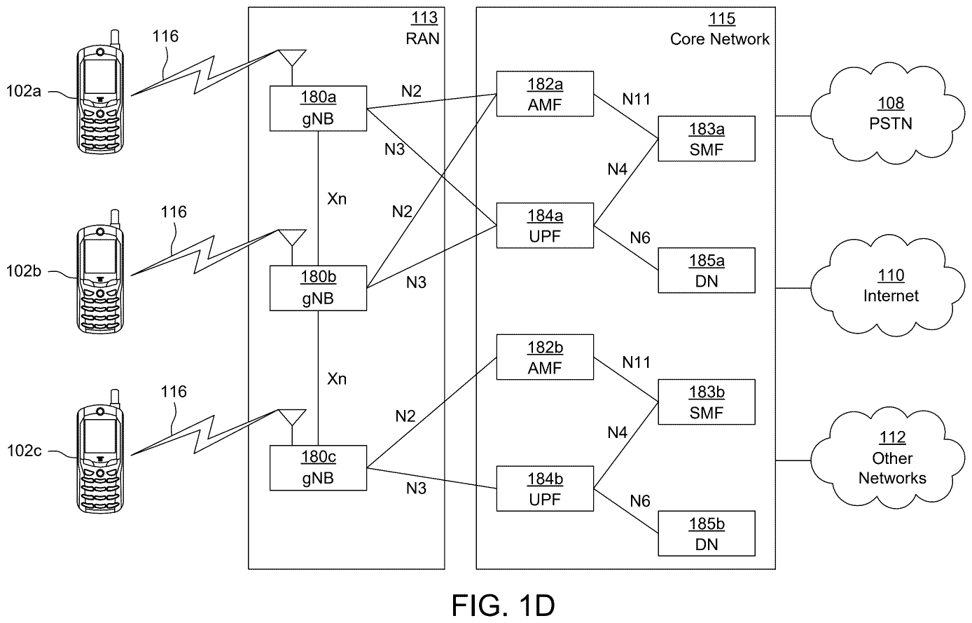

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in an uplink (UL) and/or downlink (DL), support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the various embodiments below, the term RAN node is used herein to represent any RAN node including a gNodeB and eNodeB. The terms Application Server (AS) and Application Function (AF) may be used interchangeably herein. An AS may in some cases be an Edge Application Server. The term Information Element (IE) is used herein to represent one or more parameters. An IE may be made up of one or more other IEs. The term “UPF” used herein may designate a PDU session anchor (PSA) UPF or an intermediate UPF.

According to various embodiments below, network nodes (e.g., network functions and RAN Nodes) may detect if a flow is conformant or not conformant with respect to NUM data. Conformant flows may refer to flows that exhibit behavior that is within constraints that are expected by a network and communicated with endpoint(s) using a NUM mechanism over a user plane. Non-conformant flows may refer to flows that do not exhibit behavior that is within constraints that are expected by the network. For example, the network may expect that the amount of data that is sent in a flow per unit of time is less than a value. For example, if the network detects that the amount of data that is sent in the flow per unit of time is greater than the value, then the network may consider the flow non-conformant. For example, if the network detects that the amount of data that is sent in the flow per unit of time is less than our equal to the value, then the network may consider the flow conformant. In another example of conformance related to another type of NUM data, a conformance test related to available data rate NUM data could be that the available data rate is maintained above a certain threshold. The term “endpoint” may refer to a wireless transmit/receive unit (WTRU) (e.g. a UE) or/and AS, which are the endpoints of a service data flow (SDF), where the SDF is the flow over which Network-Endpoint User Plane Metadata are exchanged as described herein. In some implementations, SDF is or includes a data flow (e.g., as identified in 3GPP 5G standards by specific characteristics, such as a 5-tuple composed of a transport protocol, source and destination IP addresses and ports) that is subject to specific quality of service and policy control rules. The terms SDF and data flow are used interchangeably herein.

Network-Endpoint User-Plane Metadata (NUM) protocols may enable communicating metadata between a network (e.g., a network node on a path of a data flow) and one or more endpoints (e.g., between a UPF and a WTRU and/or AS). For example, the network may communicate a maximum throughput for application flows to or from a WTRU (e.g., for Adaptive Bit Rate (ABR) applications that may adjust data bitrate over time, where the adaptation can be client-based, e.g., Dynamic Adaptive Streaming over HTTP (DASH), or server-based, e.g., MOQ or RTP; or, e.g., for applications that can open multiple flows dynamically, e.g., for pre-fetching content). NUM protocols may become even more necessary due to the use of encrypted service data flows, which prevent using unencrypted headers to communicate metadata.

NUM data may designate the data that is exchanged between the network and an endpoint. As described in use various embodiments below, examples of NUM data information elements (IEs) may include: a rate recommendation, an indication that a flow is not conformant with regards to a rate recommendation, an available data rate, and a service locality indication.

A NUM message may designate herein a message transmitted between a network node and an endpoint, which contains NUM data. For example, in some exemplary NUM protocols, a NUM message may be a QUIC packet, a MASQUE message (e.g., an HTTP datagram), a DHCP message, or a Router Advertisement message, MOQ message, RTP header, UDP header option, IP header option.

NUM protocols may be (e.g., typically) communicated over the user (or data) plane. This may have multiple advantages over conveying metadata through the control plane: (i) this may enable a same NUM protocol to be supported in diverse types of systems, with or without a user-control plane separation; (ii) this may enable synchronizing NUM data with PDUs they refer to, which can be useful in some use cases where NUM data correspond to a particular PDU.

Protocols that run on top of IP between a WTRU and application servers may be examples of data plane protocols. NAS may be an example of a control plane protocol.

NUM protocols may differ from existing user plane signalling such as Explicit Congestion Notification (ECN): (i) NUM protocols may be used to convey several types of metadata (such as described in use cases below), while ECN is limited to signalling congestion, e.g., a PDU was dropped, or a PDU is likely to be dropped in the future, or (e.g., for LAS) the application flow's queueing is building inside the router; (ii) even for the specific case of the rate limiting use case (see below), NUM may enable a proactive agreement to be established between the network and application before starting a session, while ECN enables only a control loop in real time during the session. The application can therefore use data from NUM to configure its application, while ECN signal is used at a later stage, i.e., during transport.

In an embodiment, a use case for NUM may be rate recommendation for media streaming in mobile networks. In this use case, a network service provider and an application service provider may cooperate for mutual benefit: the network service provider (or network) may provide a recommended rate to the application service provider (or application, or endpoint). The application may limit its throughput (e.g., by not requesting the highest resolution(s) when using adaptive bitrate media streaming; or, e.g., by limiting pre-fetching video), and on the other side the network may forward this application traffic in a manner less disruptive to the end user quality of experience (QoE) (e.g., by not filtering the traffic through a rate limiter network function). The application provider may gain a better QoE for its user, while the network operator can reduce the operating costs by limiting the usage of rate limiter network functions. The network could further use the NUM mechanism or other indications such as ECN, to indicate to a user device (e.g., a WTRU) that a flow or set of flows does not conform to the recommended rate.

In an embodiment, another use case for NUM may be providing an “available data rate” to the application, where the available data rate may be a live measurement, by the RAN, of the available portion of the guaranteed or maximum data rate which is currently unused by an application data flow. The available data rate may (e.g., today) be provided to the application provider through the AF. In some cases, it may be advantageous for the available data rate to be provided directly to the WTRU or AS using NUM, which could reduce the latency between measurement and reception by the application endpoint, and therefore could improve the reactivity of the application.

In an embodiment, another use case for NUM may be providing a “service locality” indication to a WTRU. The service locality may indicate that certain services provided to an application (e.g., transcoding, rendering) may be provided locally on site, remotely in the cloud, or in an intermediate location such as a network concentration point. The WTRU can use this indication to determine to request edge computing services, for example.

As per today there is no mechanism enabling a mobile network to use a NUM protocol, e.g., to transmit metadata from the network to an endpoint, a mechanism is therefore desired, to enable the mobile network to provide NUM data to a WTRU or AS over a user plane. This mechanism should address any of the following requirements: (i) the network may need to determine whether to provide a NUM service (e.g., for which application, service data flow, QoS flow, PDU session and/or WTRU); (ii) the network may need to determine which NUM protocol to use; (iii) the network may need to determine when to update NUM data (e.g., periodically, in response to a request by an endpoint, or in response to a network event like network-wide congestion); (iv) the network may need to determine which NUM data to provide (e.g., a throughput recommendation, an indication of non-conformance, an available data rate, an indication of service locality); and (v) the network and endpoints may need to be in agreement about the semantic of NUM values (e.g., a description of the scope of a throughput recommendation, a mapping between NUM data and actual rate values, a description of the locality codes).

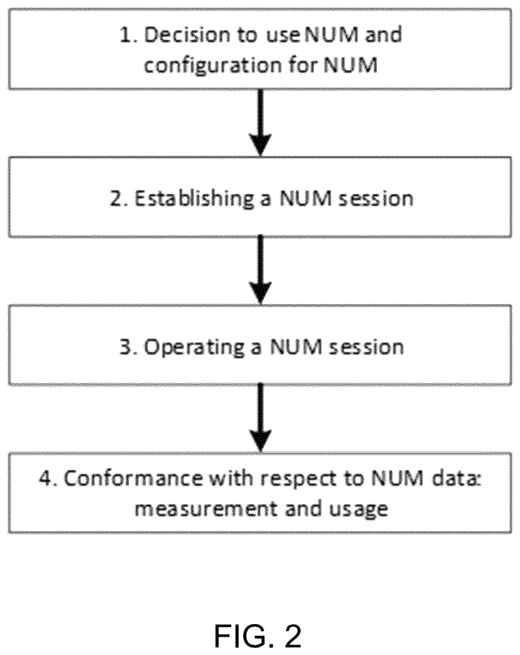

Referring to FIG. 2, an embodiment, (1) the application provider (e.g., through AF) or network service provider may configure the network (e.g., using PCC rules) to use NUM for a flow. (2) The NUM mechanism may be established in a NUM protocol-specific manner involving one or more of WTRU, UPF, AS, SMF or other Network function (NF). The network may determine when to transmit NUM data based on triggers from one or more of the WTRU, AS, a network condition detected by a NF (e.g., PCF, RAN node), an initial event, a periodic event, WTRU mobility, application event. (3) Based on the trigger, the network (e.g., UPF, or SMF through UPF) transmits NUM data towards one or more endpoints. (4) The UPF may measure conformance, by the application, with respect to the NUM data. In such case, the UPF can alter its service based on conformance (e.g., steer application traffic through a network service function) and/or can indicate conformance in PDUs to the RAN (e.g., in a Generic Tunneling Protocol (GTP) header) and/or to the WTRU and/or AS (e.g., using a NUM mechanism or in a PDU header).

This embodiment may enable NUM data to be transmitted UL and DL, in both directions. While examples are focusing on transmitting NUM data from the network to the WTRU, the embodiment described herein can be used to transmit NUM data from the network to the AS, and to transmit NUM data from an endpoint (WTRU or AS) to the network.

FIG. 2 may represent main aspects of a high-level solution for NUM. The major aspects of this process, as well as new IEs defined herein, are detailed in various embodiment below.

A NUM indication may be sent by a source node to a destination node to configure the destination node for using NUM. Examples of usage may include transmitting a NUM indication by: (i) by an AF to Network Exposure Function (NEF) or Policy Control Function (PCF) (e.g., when an AF is configuring a service data flow with NUM); (ii) by PCF to SMF (e.g., when transmitting Policy and Charging Control (PCC) rules including a NUM indication); (iii) by WTRU to SMF (e.g., when requesting the use of NUM in a PDU session establishment or modification request); (iv) by SMF to UPF, RAN node and/or WTRU (e.g., when modifying a PDU session to use NUM); (v) by UPF to SMF (e.g., when the UPF detects usage of a NUM protocol and indicates it to the SMF); (vi) by SMF to PCF (e.g., to update the PCC rule, e.g., using WTRU or UPF provided NUM information); (vii) by PCF to AF (e.g., in a notification to provide NUM configuration following an update of the PCC rule); or (viii) by an Application Provider to AF (e.g., when a 5GMS Application Provider is configuring a service data flow with NUM).

A NUM indication may include one or more the following NUM indication IEs: (i) a flag indicating whether to use NUM; (ii) a NUM protocol, which may be a specific NUM protocol, or “auto” for auto-detecting the protocol. The NUM sender (i.e., the user plane node that sends NUM data to the endpoint(s)) may be different depending on the NUM protocol (e.g., it can be the UPF or SMF); (iii) a type of NUM data (e.g., a rate recommendation, an available data rate, a service locality); (iv) NUM data scope information (e.g., is the rate recommendation for a single flow, for all flows of type “video,” for all flows of a specific application, for all flows from a WTRU/subscriber); (v) NUM data mapping (e.g., a mapping between the NUM data codepoints and a set of throughput values); (vi) one or more sources for the NUM data (e.g., is the NUM data produced by the PCF, by the network data analytics function (NWDAF), and/or other data sources); (vii) one or more NUM source data collection models (e.g., on demand model where the UPF/SMF may request NUM data from a source whenever it receives a request for NUM data from an endpoint; e.g., event-based model where the source sends an event when a NUM data should change, and where the UPF/SMF may use the latest received value when sending NUM data); (viii) one or more triggers for transmitting NUM data; (ix) the direction for NUM data transmission (from network downlink towards WTRU, from network uplink towards AS from the WTRU uplink towards the network, from the AS downlink towards the network, or a combination of these directions); (x) conformance measurement configuration IE; (xi) conformance action configuration IE; (xii) security material (e.g., keying material for sharing a secure context between the network and endpoints for NUM); and (xiii) NUM protocol parameters (e.g., transport layer port numbers, or, e.g., a context ID identifying the messages that contain NUM data).

The conformance measurement configuration IE may include one or more of: (i) an identifier of flows included in conformance measurement (e.g., one or more traffic filters identifying one of more SDFs); (ii) direction of the flow to measure (e.g., UL, DL, or both); and (iii) conformance measurement type (e.g., a throughput) and parameters (e.g., a time window).

The conformance action configuration IE may include one or more of: (i) service routing information (e.g., NFs to add or remove from the SDF path) to apply based on conformance condition (e.g., “when conformant,” “when non-conformant,” above or below a value threshold); (ii) GTP header IE (e.g., conformance flag) to include, based on conformance conditions, in PDUs forwarded to the RAN (e.g., for PDUs of a service data flow associated with the NUM indication); (iii) IE to transmit to endpoint(s) based on conformance conditions (e.g., this can be a flag in the NUM data message); (iv) a set of QoS requirements for (e.g., differentiated) treatment based on NUM data conformance, each associated with a conformance (e.g., boolean or numerical) value or value range; (v) reporting information (e.g., a rule indicating how to send a report, to one or more network functions, AS, or WTRU, where the report may include NUM data received from an endpoint and/or conformance value and/or other NUM indication IE). For example, the reporting information IE can indicate to report, to the SMF and/or WTRU, any change of conformance value to the SMF, including, e.g., a conformance indication (with a conformant or non-conformant value), the type of NUM data (e.g., rate recommendation) and the NUM data value used for conformance testing (e.g., a specific rate). The reporting information IE may include a parameter indicating for how long a conformance value should hold a new value, to trigger a report to the SMF.

In an embodiment, an aspect may be configuring the network and/or endpoints for a NUM session. An AF can request a NUM mechanism to be used on a flow, e.g., using an enhanced AF session with QoS procedure, or another procedure for influencing PDU session service. The AF may include a NUM indication in a (e.g., an enhanced) request message to the NEF or PCF. Using the NUM indication, the AF may request a (e.g., certain) type of NUM data type to be provided to the WTRU, the AS or both endpoints. The AF may (e.g., also) request a NUM protocol (although it could be set to “auto” to be detected by the UPF), and other parameters described herein).

The PCF may create or modify a PCC rule to include NUM indication IEs, upon receiving the NUM indication (e.g., from AF directly or through NEF). For example, a PCC rule may include a flag allowing/requesting a NUM mechanism to be used for a service data flow. In addition, or replacement to using input from the AF, the PCF may determine the NUM indication IEs for a PCC rule based on other aspects, such as Data Network Name (DNN), network slice (S-NSSAI), PCC rules, subscription information, pre-agreement with an Application Service Provider (ASP), class or type of traffic, subscriber information, application type, application identifier such as an Fully Qualified Domain Name (FQDN). For example, based on operator policy, the PCF may determine that all flows of a (e.g., certain) type (e.g., video), associated with a DNN and/or S-NSSAI, may be subject to receive a rate recommendation through NUM.

The SMF may determine to use a NUM mechanism based on a PCC rule and/or based on other aspects, such as DNN, network slice (S-NSSAI), PCC rules, subscription information, pre-agreement with an ASP, class or type of traffic, subscriber information, application type, application identifier such as an FQDN. The SMF determination may occur during a PDU session establishment or modification procedure, or following a message from the PCF (e.g., triggered by an AF request). Following the SMF determination, the SMF may configure the UPF, RAN, WTRU and/or PCF to enable the NUM mechanism.

The SMF may transmit a NUM indication to the UPF. The indication may include conformance related IEs in the NUM indication to the UPF. Furthermore, the indication can include a flag indicating whether to use NUM, a NUM protocol, a type of NUM data, NUM data scope, NUM data mapping information, NUM data source(s), NUM source data collection model(s), triggers transmitting NUM data, direction for NUM data transmission, security material, or other NUM indication IE. The UPF may use the NUM indication IEs to configure itself to establish and operate the NUM session (which can include, in some cases, discovering the NUM protocol). In some systems, the UPF may transmit NUM protocol parameters to the SMF, such as transport layer port numbers, to enable the NUM session establishment.

The SMF can send a NUM indication to the RAN node. The indication can include conformance related IEs.

The SMF can transmit a NUM indication to the WTRU. The indication can include conformance related IEs. Furthermore, the indication can include NUM indication IEs such as a flag indicating whether to use NUM, a NUM protocol, a type of NUM data, NUM data scope information, NUM data mapping, triggers for transmitting NUM data, NUM data direction, security material, NUM protocol parameters, or other NUM indication IE described herein. The WTRU may configure itself to use NUM, based on the NUM indication IEs.

In some systems, the PCF may transmit a NUM indication to the WTRU, as part of an enhanced WTRU Route Selection Policy (URSP) rule. The enhanced URSP rule may, for example, include a NUM indication in a new NUM route selection component. The enhanced URSP rule may enable the WTRU to determine to use NUM for an application flow matching the URSP rule traffic descriptor. Based on this determination, the WTRU may include a NUM indication IE in the PDU session establishment or modification request message, which informs the SMF to use NUM for the PDU session and/or for a specific service data flow within the PDU session.

In an embodiment, an aspect may be establishing a NUM session, e.g., getting the network and endpoints to a point where it may become possible to transmit and receive NUM messages containing NUM data.

If the NUM protocol is configured in the UPF/SMF as “auto,” the UPF/SMF may detect the NUM protocol, e.g., by analyzing the traffic flow PDUs. Well-known security material may be used to protect initial QUIC packets, which can therefore be analyzed by the UPF: for example, the QUIC version of initial packets can enable determining the NUM protocol on the flow. In another example, a WTRU may indicate support for one or more NUM protocols in a PDU session establishment or modification request message (e.g., in a new “NUM capabilities” IE). The SMF may provide, to the UPF, a list of the one or more NUM protocols supported by the WTRU, based on the NUM capabilities, which may enable the UPF to (e.g., efficiently) detect the NUM protocol being used among this list. In yet another detection example, the WTRU may indicate, to the UPF, its support for using NUM, and possibly for a specific set of NUM data, using a HTTP header during the establishment of a MASQUE tunnel with the UPF (e.g., “num-data: rate-recommendation” in the CONNECT request may indicate support for receiving rate recommendation from the network using a control message in MASQUE).

A NUM session establishment may be NUM protocol specific. As a first example, when using a QUIC-based NUM protocol, the WTRU and AS can establish a QUIC connection specifying a NUM-aware QUIC version. During the lifetime of the end-to-end QUIC session, in some NUM protocols the WTRU or AS may send a message coalesced with a PDU, to trigger the insertion of NUM data by the UPF. In some NUM protocols, the UPF may directly send NUM data in a message coalesced with a PDU towards the WTRU or AS. In some NUM protocols, an endpoint (e.g., WTRU) may initiate the use of a NUM protocol by sending a message coalesced with a PDU, which is detected by the proxy (e.g. UPF). From this point, the proxy may send NUM data messages coalesced with or adjacent to PDUs exchanged by the endpoints.

As a second example, when using a DHCP-based NUM protocol, the SMF may include a NUM data IE in a DHCP message sent to the WTRU during the PDU session establishment, or later when/if the WTRU requests a renewal of the lease.

As a third example, when using an IP router advertisement-based NUM protocol, the SMF may include a NUM data IE in a router advertisement message sent to the WTRU during the PDU session establishment, or later, during the lifetime of the PDU session.

As a fourth example, when using a MASQUE-based NUM protocol, the UPF may send to the WTRU a MASQUE control message (e.g., an HTTP datagram) including NUM data, at any time during the lifetime of the MASQUE tunnel (e.g., during the lifetime of the MA-PDU session that is using this MASQUE tunnel).

In an embodiment, an aspect may be operating a NUM session, which includes, for the NUM data sender, receiving, from any of the endpoint, or from one or more core network entities, a trigger to send NUM data. Triggers for sending NUM data may be received by a NUM data sender (e.g., UPF or SMF) or by a NUM data source (e.g., NWDAF or PCF). Trigger for sending NUM data may include any of: (i) the (e.g., media) application session started (e.g., when the UPF receives the first, or Nth PDU, where N is configured or implementation based); (ii) a network condition changed (e.g., a network congestion event occurred, a WTRU relocation to a new UPF or RAN node, the network usage changed due to a higher or lower number of concurrent sessions; (iii) the NUM data changed (e.g., the PCF recalculated the NUM data for one or more WTRUs/flows, e.g., based on a media session starting or ending); (iv) a timer elapsed (e.g., periodic, or a certain time after a failed conformance check); and (v) receiving a NUM data request message from an endpoint.

Upon receiving a trigger to send NUM data, a NUM data source may send the NUM data value to the NUM data sender. Upon receiving a trigger to send NUM data, a NUM data sender may request a NUM data value from a NUM data source. In either case, the NUM data sender may proceed with sending the NUM data at the next opportunity (e.g., depending on the NUM protocol, this can be immediately or when receiving a PDU from an endpoint).

During the lifetime of a service data flow configured with NUM, the NUM sender (e.g., UPF or SMF) may transmit NUM data with UL and/or DL PDUs, based on its configuration from the NUM indication. Depending on the NUM source data collection model, when triggered the NUM sender may transmit the NUM data that is locally available or may request a new NUM data value from the data source(s). When using a NUM protocol that enables bidirectional NUM data transmission, the endpoints (e.g., WTRU and AS) may also send NUM data to the network (e.g., UPF).

Upon receiving the NUM data, the receiver (e.g., WTRU, AS, UPF) may use the NUM data based on its earlier NUM configuration, e.g., using IEs from a NUM indication obtained earlier, including for example the NUM data type, mapping, and scope. For example, in a first use case, a WTRU and/or an AS may use a “rate recommendation” NUM data to determine to adjust/limit the requested/delivered streaming rate, and to adjust/limit the amount of prefetching by the application. For example, in a second use case, a WTRU and/or an AS may use an “available data rate” NUM data to adjust/increase/decrease the application flow data rate, e.g., to maximize the use of available data rate and maximize QoE for the end user. For example, in a third use case, a WTRU may use a “service locality indication” NUM data to determine whether to request, or not, offloading of certain functions of an application.

In an embodiment, an aspect may be conformance. This aspect may be present in use cases where NUM data is a recommendation or other form of target value, whose effect can be measured by the network (e.g., a throughput recommendation).

The SMF may configure the UPF for conformance testing and/or related actions with respect to NUM data, by providing a NUM indication including conformance measurement and/or action configuration IEs. For example, the SMF may include the NUM indication in a N4 session establishment or modification message. For example, ae Packet Detection Rule IE of the N4 message may (e.g., be enhanced to) include a (e.g., new) NUM description IE which includes NUM indication IEs. Alternatively, the NUM description IE may be present in another data structure within the N4 message (e.g., in a dedicated metadata detection and reporting rule). Upon receiving the N4 message, the UPF may configure itself to measure conformance and/or perform related actions.

The SMF may configure the RAN node for (e.g., differentiated) treatment based on NUM data conformance, by transmitting to the RAN node, e.g., in an N2 message that carries a PDU session establishment or modification response message, a NUM indication including a set of QoS requirements for (e.g., differentiated) treatment based on NUM data conformance. The indication may include two or more QoS requirements, each along with a corresponding conformance value (e.g., “conformant,” “non-conformant,” or a numerical conformance value range). Upon receiving the indication, the RAN node may configure itself to provide (e.g., differentiated) QoS treatment, based on a conformance value from the UPF.

In various embodiments, the SMF may configure the RAN node for conformance testing. The RAN node may perform the conformance measurement. The RAN node may use the result to provide (e.g., differentiated) QoS treatment.

In an embodiment, where the UPF performs the conformance measurement, and where the NUM data is a rate recommendation, the UPF may measure the throughput for the flow(s) identified by the PDR, over a time window and for a direction provided in the NUM indication. The UPF may indicate a conformance value to the RAN node, e.g., by including a conformance IE in the GTP header encapsulating the PDU. The UPF may for example include the conformance value in all PDUs' GTP headers, using the latest conformance measurement result. The RAN may provide (e.g., differentiated) treatment based on the conformance IE, e.g., to boost the priority of conforming flows vs. non-conforming flows. The UPF can route conforming vs. non-conforming flows differently. For example, the UPF routes non-conforming flows through a service function that performs a traffic shaping operation. In various embodiments, the UPF can send an event to the SMF or PCF, including the conformance value, when the conformance value changes (or only after the new value is maintained for a certain time, which may be configured by the SMF/PCF). The SMF/PCF may, based on the reported conformance value, trigger a PDU session modification procedure, to insert an I-UPF (including a traffic shaping function) if the flow is non-conformant, or to remove the I-UPF if it is conformant. The UPF may also send the conformance value in a conformance IE to the WTRU (and/or AS) along with the PDU. The conformance IE may be, e.g., a flag or number field within a compound NUM data type (e.g., rate recommendation+conformance) or as a standalone new NUM data type. The WTRU (and/or AS) application may use the conformance IE to adapt its behavior (e.g., if the flow is non conformant, the WTRU may decide to reduce its requested streaming rate or to temporarily stop pre-fetching content).

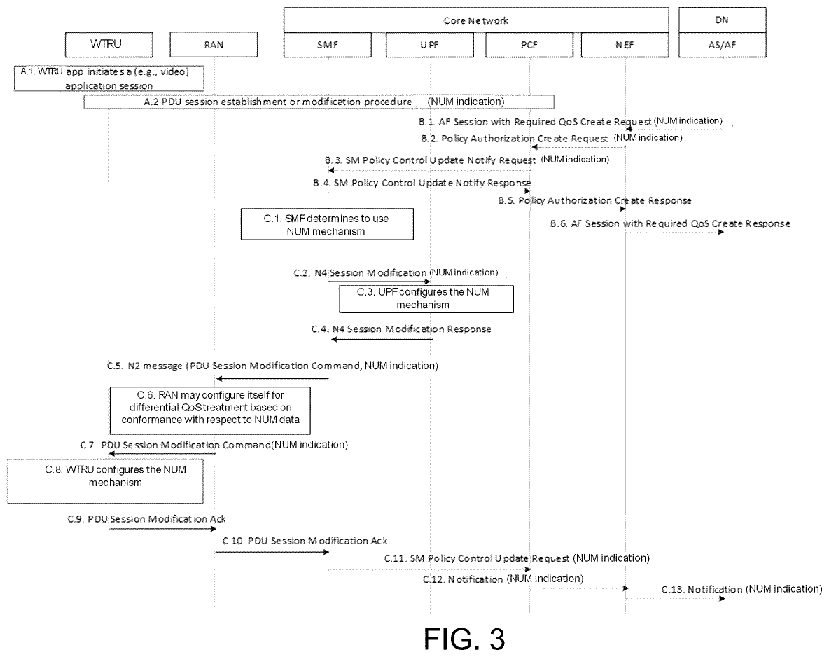

Referring to FIG. 3, an example of a signalling diagram illustrating an example of a procedure for configuring a NUM session is shown.

The section ‘A’ of FIG. 3 represents the establishment of modification of a PDU session to establish an application session.

In step A.1, a WTRU application may initiate an (e.g., video) application session.

In step A.2, the WTRU may look up into URSP rules based on the characteristics of the application session and may determine to establish or modify a PDU session. In various embodiments, the URSP rules may contain a NUM indication, e.g., a flag requesting to use NUM, a NUM protocol and/or other NUM indication IEs. Based on the NUM indication in the URSP rules, the WTRU may include NUM indication IEs in the PDU session establishment or modification request message to the SMF.

The section ‘B’ of the FIG. 3 represents an AF configuring the NUM for a flow.

In steps B. 1-B.2, a (e.g., 5G) Media Streaming (MS) application provider may configure an AF to use NUM. The AF may transmit a (e.g., AF session with Required QoS) request message including a NUM indication, e.g., a flag requesting to use NUM, a NUM protocol and/or other NUM indication IEs. The AF may transmit the request message to the PCF through the NEF (e.g., using a Policy Authorization Create Request), or in some cases directly to the PCF. The PCF may create, or update PCC rules based on the NUM indication, e.g., by adding NUM indication IEs in the PCC rule.

In step B.3, the PCF may notify the SMF by transmitting a message (e.g., SM Policy Control Update Notify Request) including a (e.g., PCC rule including a) NUM indication.

In steps B.4/B.5/B.6, the SMF may transmit a reply to the PCF. The PCF may transmit a reply to the AF through the NEF or directly. These replies may indicate that the new configuration has been accepted by the network.

The section ‘C’ of the figure represents the SMF configuring the NUM for a flow.

In step C.1, the SMF may determine to use a NUM mechanism, based on the NUM indications from PCF and/or from the WTRU, and/or based on SMF configuration. The SMF may register for event notifications from an NF (e.g., PCF) to receive NUM data updates. For example, the SMF may send a request to the PCF to send updates to the recommended throughput recommendation for the flow(s). In some cases, this registration from the SMF may be done in the B.4 message, or it may be implicit, based on the NUM indication present in the PCC rule. The PCF may calculate the recommended throughput for the flow(s), based on the network usage (e.g., from OAM/management plane) and user subscription.

In steps C.2/C.3/C.4, the SMF may transmit a (e.g., N4 session modification) message to the UPF, including a NUM indication. The UPF, based on the NUM indication, may configure itself to use the NUM mechanism (e.g., to detect QUIC messages that contain a NUM data request, for example). The UPF may transmit a (e.g., N4 session modification) response message.

In steps C.5/C.6, the SMF may transmit an N2 message to the RAN, including a NUM indication (and, e.g., a PDU session modification command). The NUM indication may for example include conformance action configuration, to request the RAN to provide differentiate QoS based on conformance with respect to NUM data. Based on the NUM indication, the RAN configures itself, e.g., to provide (e.g., differentiated) QoS treatment based on conformance with respect to NUM data.

In steps C.7/C.8/C.9/C.10, a RAN node may forward the PDU session modification command, which may include a NUM indication, to the WTRU. The WTRU may configure itself to use the NUM mechanism. For example, the WTRU application may initiate the end-to-end QUIC connection with AS, that supports NUM data messages (e.g., include a NUM capability in the transport parameters of the QUIC connection). The WTRU may transmit an acknowledgement message to the RAN node, and the RAN node may transmit an acknowledgement message to the SMF. In some systems, the message C.7 does not include a NUM indication and the WTRU may configure itself to use the NUM mechanism, based on, e.g., application configuration or a NUM indication in a URSP rule.

Steps C.11/C.12/C.13 may be present in cases where the AF configured NUM (in steps B), or otherwise when the AF requested a notification. In steps C.11/C.12/C.13, the SMF may transmit a (e.g., SM policy control update) request to the PCF, including, e.g., a PCC rule that includes a NUM indication. The NUM indication may include information from the WTRU or UPF, e.g., a flag to use NUM, a NUM protocol, and/or other NUM indication IEs such as a port number or context ID. The PCF may notify the AF directly or through the NEF, including a NUM indication into the notification message. The AF may use the NUM indication IEs, e.g., to determine to use a NUM protocol, and/or to map the NUM data to meaningful values. In a case (not represented) where the WTRU (or SMF or other node) would reject using NUM, the notification to the AF may indicate that NUM has been rejected for this flow (and the reason).

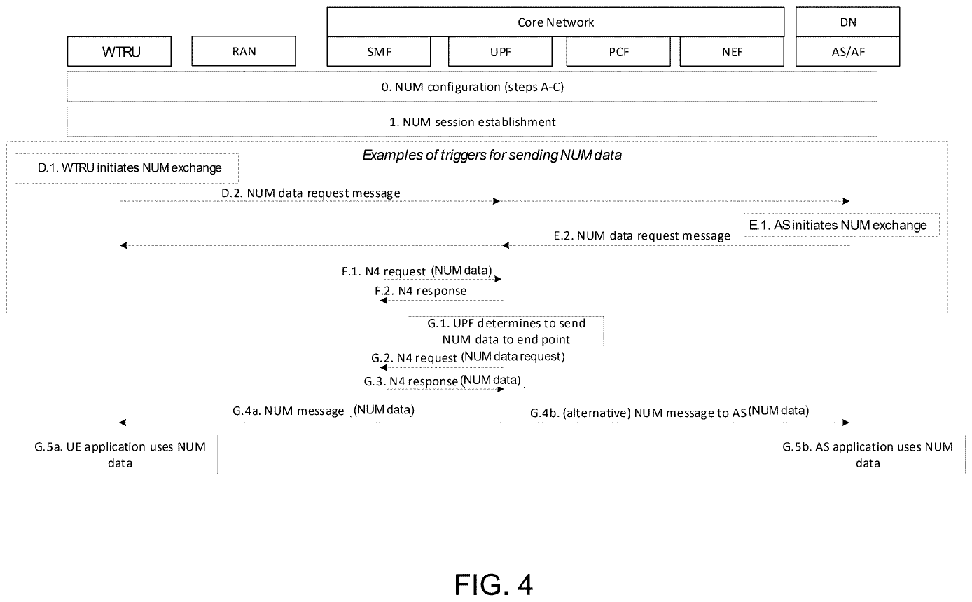

Referring to FIG. 4, an example of a signalling diagram illustrating an example of a procedure for a NUM session establishment and operation. In an embodiment, the NUM data sender may be the UPF. With some NUM protocols, the NUM data sender may be the SMF, which is not described but can be derived from this procedure by having the SMF perform the actions described here for the UPF, and by having NUM messages to and from the SMF transmitted through the UPF. Furthermore, additional procedures may be derived, where the WTRU and/or AS send NUM data that is received by the UPF.

In step 0, the NUM mechanism may be configured as described in step ‘A’ to step ‘C’ of FIG. 3.

In step 1, the NUM session is established, e.g., any necessary step may be performed to enable the UPF/SMF and WTRU/AS to exchange NUM data. This step may be NUM protocol specific, and some examples are described herein.

The sections ‘D’, ‘E’, and ‘F’ of FIG. 4 represents different exemplary triggers for initiating the NUM data transmission. One or more of ‘D’, ‘E’, ‘F’, or an alternative trigger may be used in a system. Alternative triggers may include a timer on the UPF, or a notification from another NF.

In steps D.1/D.2, the WTRU may determine to trigger a NUM data transmission, e.g., based on application logic (e.g., the application may wish to receive NUM data periodically or upon specific events within the application). The WTRU may transmit a NUM data request message on the user plane, uplink through the UPF. The NUM data request message may be, for example, a QUIC packet coalesced with or adjacent to an end-to-end PDU, or a MASQUE message. A message adjacent to the end-to-end QUIC connection share important characteristics with PDUs of the end-to-end connection, e.g., it uses the same 5-tuple as the end-to-end connection (where the 5-tuple is composed of source and destination IP address and UDP ports, and transport protocol). A message coalesced with a PDU of the end-to-end QUIC connection is sent in the same packet (e.g., same IP packet and/or same UDP datagram) as the PDU of the end-to-end QUIC connection.

Steps ‘E.1’ and ‘E.2’ are like steps ‘D.1 and ‘D.2’, where the AS triggers the NUM exchange instead of the WTRU.

In steps ‘F.1’ and ‘F.2’, the SMF (e.g., based on an internal trigger or based on a notification from PCF) may provide NUM data to the UPF, e.g., in an N4 session request message. The SMF may have registered for notification(s) from data sources such as PCF, prior to ‘F.1’, to receive notifications including data values that can be used as NUM data, such as a rate recommendation from PCF (e.g., each time the data value changes). Alternatively, another NF may provide NUM data to the UPF, e.g., in a notification message that may have been subscribed to by the UPF. The UPF may transmit a response message to acknowledge to request/notification message.

The section “G” of the figure represents the NUM data transmission. In step G.1, the UPF may determine to transmit NUM data to endpoint(s), based on its earlier NUM configuration (e.g., in steps ‘C’) and based on triggers defined herein (e.g., ‘D’, ‘E’, ‘F’, or others).

In steps ‘G.2’ and ‘G.3’, the UPF may, e.g., if the NUM source data collection model is on-demand, request a NUM data value from a data source, and may receive the NUM data from the data source. The SMF may be a data source in FIG. 4, however other data sources may be used instead of or in addition to the SMF, e.g., PCF, NWDAF, or UDM.

The UPF may transmit a NUM message to the WTRU (step ‘G.4a’) and/or AS (step ‘G.4b’) depending on its earlier NUM configuration (e.g., in steps ‘C’). In steps ‘G.4a’ and ‘G.5a’, the UPF may transmit a NUM message including the NUM data to the WTRU in a NUM protocol specific fashion as described herein. In steps ‘G.4b’ and ‘G.5b’, the UPF may transmit a NUM message including the NUM data to the AS in a NUM protocol specific fashion as described herein. Depending on the NUM protocol, the NUM message may be coalesced with an end-to-end PDU, or adjacent with the flows' PDU, or a separate message. The WTRU and/or AS may use the NUM data as described herein.

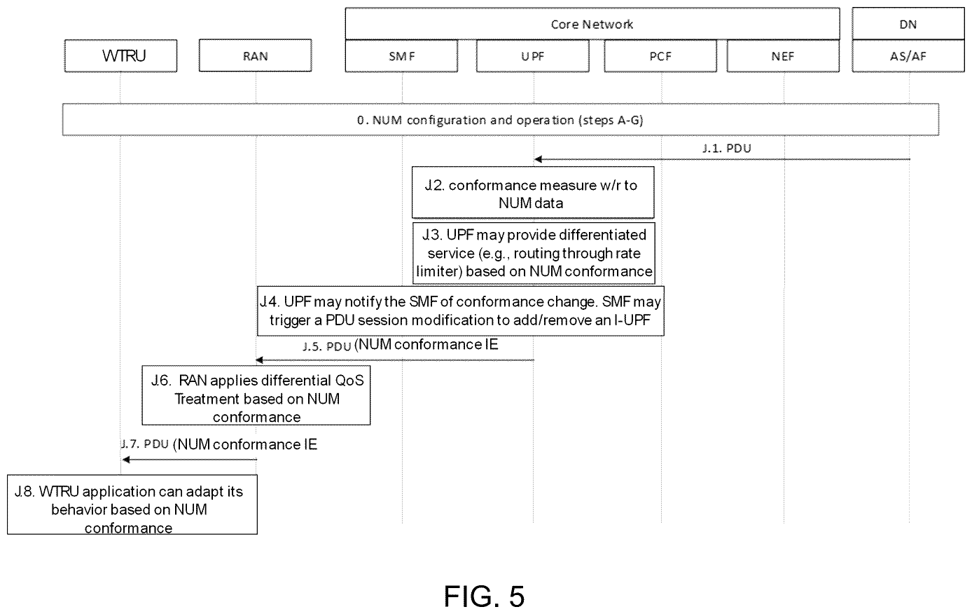

Referring to FIG. 5, an example of a signalling diagram illustrating an example of a procedure for NUM conformance measurements and usage is shown.

In step 0, the NUM mechanism may be configured and operated as described in steps ‘A’ of FIG. 3 to step ‘G’of FIG. 4.

The section ‘J’ of FIG. 5 represents an example of a NUM conformance measurement and a usage.

In step ‘J.1’, the AS may transmit an end-to-end PDU towards the WTRU. The PDU may be routed through the PSA UPF.

In step ‘J.2’, the UPF may identify the PDU as being part of the service data flow configured earlier to use a NUM mechanism. Based on earlier NUM conformance measurement configuration (e.g., in steps ‘C’ of FIG. 3), the UPF may perform a conformance measurement, with respect to NUM data. For example, the UPF may measure the throughput of the service data flow within a configured time window and may compare it with the rate recommendation which was transmitted earlier as NUM data to an endpoint.

In step ‘J.3’, based on earlier conformance action configuration (e.g., in steps ‘C’ of FIG. 3), the UPF may provide (e.g., differentiated) service (e.g., routing the PDU through a rate limited network function).

In step ‘J.4’, based on earlier conformance action configuration (e.g., in steps ‘C’ of FIG. 3), the UPF may notify the SMF of the conformance value (e.g., the UPF can send a notification each time the conformance changes, or each time the conformance changes and stays stable for a certain duration). The SMF may trigger a PDU session modification for this purpose, e.g., to add or remove an Intermediate UPF (I-UPF), and (not shown in figures). The role of the I-UPF, for example, may be to apply rate limiting on traffic that passes through it. Furthermore, the SMF may transmit a message to the PCF, indicating the conformance value, which may trigger the PCF to update PCC rules, triggering the update of QoS rules on the WTRU and/or QoS profiles in the RAN.

In step ‘J.5’, the UPF may forward the PDU towards the WTRU through the RAN node. The UPF may include a NUM conformance IE in a GTP header (for it to be used by the RAN). The UPF may include a NUM conformance IE in the PDU, e.g., using the NUM mechanism or a PDU header IE (e.g., for the conformance IE to be used by the WTRU).

In step ‘J.6’, based on earlier conformance action configuration (e.g., in steps ‘C’ of FIG. 3) the RAN node may use the conformance IE to provide (e.g., differentiated) QoS treatment to the PDU.

In step ‘J.7’, the RAN node may forward the PDU towards the WTRU.

In step ‘J.8’, the WTRU may receive the PDU which may include a conformance IE. The WTRU application may use the conformance IE to adapt its behavior to either become conformant again, or stay conformant, to maintain a good QoE for the end user (e.g., reduce pre-fetching or reduce its requested media streaming rate).

Based on FIG. 3, FIG. 4 and FIG. 5, in an embodiment, a method for NUM configuration, transmission and usage may comprising any of the following steps.

The following configuration steps may be performed on the UPF. The UPF may receive from the SMF an indication to use NUM for a flow (e.g., service data flow or QoS flow). The indication may additionally include a NUM protocol and other NUM indication IEs. The UPF may configure a NUM mechanism based on the indication. The UPF may transmit a reply message to the SMF indicating that the configuration is completed.

The following steps for sending NUM data may be performed on the UPF. The UPF may receive a trigger to transmit NUM data (e.g., from a WTRU, an AS, a SMF, a PCF or another NF). In some cases, the UPF may retrieve NUM data from an NF. Per example, the UPF may transmit a request, to SMF/PCF/NF, for NUM data, and the UPF may receive, from SMF/PCF/NF, a response including NUM data. The UPF may then transmit, (e.g., over the user plane) to an endpoint (the WTRU or the AS) a NUM message including NUM data.

The following steps to act on conformance to NUM data may be performed on the UPF. The UPF may receive a PDU from an endpoint (the WTRU or the AS). The UPF may measure the conformance of the flow regarding the NUM data.

Based on the conformance results of the measurements, the UPF may perform one or more of the following actions: (i) transmitting NUM conformance IE to the RAN node with the PDU, e.g., to request (e.g., differentiated) QoS handling based on conformance; (ii) routing the PDU through an NF, i.e., forwarding the PDU towards the RAN through a user plane function (e.g., a rate limiter UPF); (iii) transmitting NUM conformance IE to the WTRU with the PDU, e.g., to allow for WTRU application action based on conformance; and (iv) transmitting a notification message to the SMF (e.g., to enable the SMF to add or remove an Intermediate UPF to/from the PDU session, where the I-UPF can for example provide a rate limiter function to flows on the PDU session).

The following steps may be performed on the RAN node. The RAN may receive a NUM indication, including configuration of (e.g., differentiated) QoS treatment based on NUM conformance. The RAN may configure (e. g;, differentiated) QoS treatment based on NUM conformance. The RAN may receive a PDU with a NUM conformance IE (e.g., in GTP header). The RAN may apply (e.g., differentiated) QoS based on NUM conformance IE. The RAN may forward the PDU towards the WTRU.

The following steps may be performed on the WTRU. The WTRU may receive from the network (e.g., from the SMF through the RAN) an indication, including parameters of a NUM mechanism. The WTRU may configure itself to use the NUM mechanism. The WTRU may establish an end-to-end service data flow with an AS, with support for the NUM mechanism. In some cases, the WTRU may trigger the NUM mechanism by transmitting a message coalesced with a PDU sent towards the AS. The WTRU may receive a NUM message including NUM data. The NUM data may indicate, for example, a rate recommendation. The WTRU may apply/perform the rate recommendation (e.g., limiting the requested rate in an adaptive streaming application, and/or limiting the amount of prefetching by an application). The WTRU may receive a PDU indicating a conformance or a non-conformance to the NUM data, such that, in case of non-conformance, the WTRU may apply one or more corrective actions to modify (reduce or increase) the data rate under the recommended rate (e.g., limiting the requested rate in an adaptive streaming application, and/or limiting the amount of prefetching by an application).

The following steps may be performed on the SMF. The SMF may receive, e.g., from PCF, a policy rule including a NUM indication. The SMF may determine, based on the indication, to use a NUM mechanism. The SMF may transmit (e.g., to the UPF) a configuration message including at least a part of the NUM indication. The SMF may receive (e.g., from the UPF) a configuration response. The SMF may transmit (e.g., to the WTRU through the RAN node) a PDU session message including at least a part of the NUM indication.

In various embodiments, the SMF may register for NUM data with a data source (e.g., PCF). The SMF may receive a notification including a NUM data. The SMF may transmit, to the UPF, a message including the NUM data.

In an embodiment, a method, implemented in a first network endpoint node, may comprise a step wherein the first network endpoint node may receive, (e.g., from a network), a first message comprising first information indicating a configuration of metadata parameters for communicating data flow with one or more other network endpoint nodes. The method may comprise a step wherein the first network endpoint node may transmit, to the network, a second message comprising second information indicating a request for one or more metadata parameters related to a communication of data flow with a second network endpoint node of the one or more other network endpoint nodes. The method may comprise a step wherein the first network endpoint node may receive, from the network, a third message comprising third information indicating the one or more metadata parameters related to the communication of the data flow with the second network endpoint node. The method may comprise a step wherein the first network endpoint node may receive, from the network, a fourth message comprising conformance information related to the communication of the data flow with the second network endpoint node; and a step wherein the first network endpoint node may perform one or more corrective action on the received one or more metadata parameters based on the conformance information (e.g., indication).

The first network endpoint node may be a wireless transmit/receive unit, WTRU, and the second network endpoint node may be an application server node of the network. The one or more metadata parameters may comprise data flow rate for communicating the data flow with the second network endpoint node. The one or more corrective actions may comprise adjusting the data flow rate, increasing the data flow rate or decreasing the data flow rate.

The method may comprise a step wherein the first network endpoint node may establish an end-to-end service data flow with the second network endpoint node supporting the metadata parameters. prior to transmit the second message The metadata parameters may be related to a network-endpoint user plane metadata mechanism involving one or more core network entities.

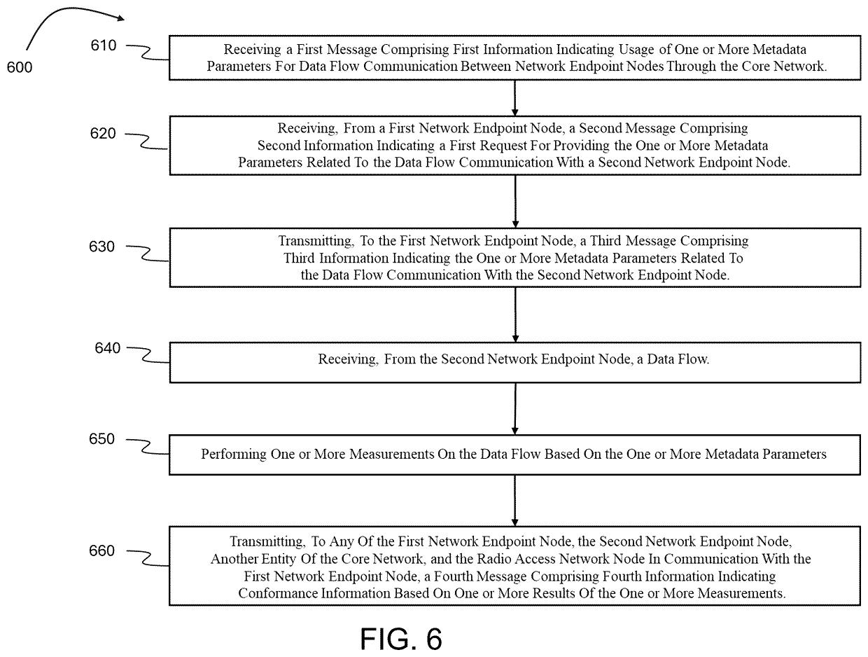

Referring to FIG. 6, in an embodiment, a method 600, implemented in an entity of a core network (e.g., a user plane function entity), may comprise a step wherein the entity of the core network may receive a first message comprising first information indicating usage of one or more metadata parameters for data flow communication between network endpoint nodes through the core network. The one or more metadata parameters may be related to a network-endpoint user plane metadata mechanism involving at least the entity of the core network. The method 600 may comprise a step wherein the entity of the core network may receive 620, from a first network endpoint node, a second message comprising second information indicating a first request for providing the one or more metadata parameters related to the data flow communication with a second network endpoint node. The method 600 may comprise a step wherein the entity of the core network may transmit 630, to the first network endpoint node, a third message comprising third information indicating the one or more metadata parameters related to the data flow communication with the second network endpoint node. The method 600 may comprise a step wherein the entity of the core network may receive 640, from the second network endpoint node, a data flow. The method 600 may comprise a step wherein the entity of the core network may perform 650 one or more measurements on the data flow based on the one or more metadata parameters. The method 600 may comprise a step wherein the entity of the core network may transmit 660, to any of: (i) the first network endpoint node, (ii) the second network endpoint node, (iii) another entity of the core network, and (iv) the radio access network node in communication with the first network endpoint node, a fourth message comprising fourth information indicating conformance information based on one or more results of the one or more measurements.

The fourth message may be transmitted coalesced or adjacent with a packet data unit transmitted to the first network endpoint node. The fourth message transmitted to the radio access network node in communication with the first network endpoint node may further comprise a second request for handling a quality of service based on the conformance information.

The method 600 may comprise a step wherein the entity of the core network may transmit to the another entity of the core network, a seventh message comprising a third request for providing the one or more metadata parameters to the entity of the core network; and a step wherein the entity of the core network may receive, from the another entity of the core network, a response message to the third request comprising information indicating the one or more metadata parameters.

The method 600 may comprise a step wherein the entity of the core network may receive a fifth message comprising fifth information indicating one or more triggering conditions for transmitting the third information. The one or more triggering conditions may comprise any of:
(i) starting of communication of the data flow, (ii) a relocation of the first network endpoint node from one or more current network entities to one or more new network entities of the network, (iii) receiving the second message, (iv) a usage of the core network has changed, (v) metadata parameters changed, and (vi) a timer elapsed. The fifth message may be received from the first network endpoint node, the second network endpoint node, or from another entity of the core network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in an entity of a core network, the method comprising:
receiving a first message comprising first information indicating usage of one or more metadata parameters for data flow communication between network endpoint nodes through the core network;
receiving, from a first network endpoint node, a second message comprising second information indicating a first request for providing the one or more metadata parameters related to the data flow communication with a second network endpoint node;
transmitting, to the first network endpoint node, a third message comprising third information indicating the one or more metadata parameters related to the data flow communication with the second network endpoint node;
receiving, from the second network endpoint node, a data flow;
performing one or more measurements on the data flow based on the one or more metadata parameters; and
transmitting, to any of the first network endpoint node, the second network endpoint node, another entity of the core network, and a radio access network node in communication with the first network endpoint node, a fourth message comprising fourth information indicating conformance information based on one or more results of the one or more measurements.

2. The method of claim 1, wherein the one or more metadata parameters are related to a network-endpoint user plane metadata mechanism involving at least the entity of the core network.

3. The method of claim wherein the entity of the core network is a user plane function entity.

4. The method of claim any 1 to claim 3, wherein the one or more metadata parameters indicate data flow rate for communicating the data flow.

5. The method of claim-to claim 4, comprising receiving a fifth message comprising fifth information indicating one or more triggering conditions for transmitting the third information.

6. The method of claim 5, wherein the one or more triggering conditions comprise any of: (i) starting of communication of the data flow, (ii) a relocation of the first network endpoint node from one or more current network entities to one or more new network entities of the network, (iii) receiving the second message, (iv) a usage of the core network has changed, (v) metadata parameters changed, and (vi) a timer elapsed.

7. The method of claim 5, comprising receiving the fifth message from the first network endpoint node, the second network endpoint node, or from another entity of the core network.

8. The method of claim 1, wherein the fourth message is transmitted coalesced or adjacent with a packet data unit transmitted to the first network endpoint node.

9. The method of claim 1, comprising transmitting to the radio access network node in communication with the first network endpoint node, the fourth message comprising a second request for handling a quality of service based on the conformance information.

10. The method of claim 1, comprising:
transmitting, to the another entity of the core network, a seventh message comprising a third request for providing the one or more metadata parameters to the entity of the core network; and
receiving, from the another entity of the core network, a response message to the third request comprising information indicating the one or more metadata parameters.

11. An entity of a core network comprising a processor, and a memory, and configured to:
receive a first message comprising first information indicating usage of one or more metadata parameters for data flow communication between network endpoint nodes through the core network;
receive, from a first network endpoint node, a second message comprising second information indicating a first request for providing the one or more metadata parameters related to the data flow communication with a second network endpoint node;
transmit, to the first network endpoint node, a third message comprising third information indicating the one or more metadata parameters related to the data flow communication with the second network endpoint node;
receive, from the second network endpoint node, a data flow;
perform one or more measurements on the data flow based on the one or more metadata parameters; and
transmit, to any of the first network endpoint node, the second network endpoint node, another entity of the core network, and a radio access network node in communication with the first network endpoint node, a fourth message comprising fourth information indicating conformance information based on one or more results of the one or more measurements.

12. The entity of the core network of claim 11, wherein the one or more metadata parameters are related to a network-endpoint user plane metadata mechanism involving at least the entity of the core network.

13. The entity of the core network of claimany wherein the entity of the core network is a user plane function entity.

14. The entity of the core network of claim 11, wherein the one or more metadata parameters indicate data flow rate for communicating the data flow.

15. The entity of the core network of claim 11, configured to receive a fifth message comprising fifth information indicating one or more triggering conditions for transmitting the third information.

16. The entity of the core network of claim 15, wherein the one or more triggering conditions comprise any of: (i) starting of communication of the data flow, (ii) a relocation of the first network endpoint node from one or more current network entities to one or more new network entities of the network, (iii) receiving the second message, (iv) a usage of the core network has changed, (v) metadata parameters changed, and (vi) a timer elapsed.

17. The entity of the core network of claim 15, configured to receive the fifth message from the first network endpoint node, the second network endpoint node, or from another entity of the core network.

18. The entity of the core network of claim 11, wherein the fourth message is transmitted coalesced or adjacent with a packet data unit transmitted to the first network endpoint node.

19. The entity of the core network of claim 11, configured to transmit to the radio access network node in communication with the first network endpoint node, the fourth message comprising a second request for handling a quality of service based on the conformance information.

20. The entity of the core network of claim 11, configured to:
transmit, to the another entity of the core network, a seventh message comprising a third request for providing the one or more metadata parameters to the entity of the core network; and
receive, from the another entity of the core network, a response message to the third request comprising information indicating the one or more metadata parameters.
